(19) United States
(12) Patent Application Publication
(10) Pub. No.: US 2005/0254091 A1
(43) Pub. Date: Nov. 17, 2005

(54) Means to facilitate delivery of electronic documents into a postal network

(75) Inventors: Steven P. Cranitch, West End (AU); David A. Ireland, Sydney (AU)

Correspondence Address: DARBY & DARBY P.C., P. O. BOX 5257, NEW YORK, NY, 10150-5257, US

(73) Assignee: EPIP Pty. Ltd., West End (AU)

(21) Appl. No.: 11/099,205

(22) Filed: Apr. 4, 2005

Related U.S. Application Data
(63) Continuation of application No. PCT/AU03/01102, filed on Aug. 28, 2003.

(30) Foreign Application Priority Data
Oct. 4, 2002 (AU) 2002951921

(51) Int. Cl. G06F 15/00

(52) U.S. Cl. 358/1.18

(57) ABSTRACT

An automated hybrid mail system/method which sends a graphic image file from the sender's terminal into a postal network via a remote printing facility . The system checks the recipient's address is correctly located on the graphic image file before sending and optionally verifying the recipient's address and adding a correct Delivery Point ID and bar code. Client-side operations require no filling in of pre-defined fields or templates; any computer application that produces a printable application document can be used. Preferably, a single-click or simple operation by the sender can send the application document to be printed as a hardcopy document and mailed to a recipient The server-side operations are automated. The system tracks the graphic image file using a unique identification number allocated when the graphic image file is created on the sender's terminal.

### CROSS-REFERENCE TO RELATED APPLICATIONS

This application is a continuation of PCT International Application No. PCT/AU2003/001102, filed Aug. 28, 2003 designating the United States of America, claiming the benefit of Australian Patent Application No. 2002951921, filed Oct. 4, 2002. The International Application was published in English on Apr. 15, 2004 under publication number WO 2004/032002.

### TECHNICAL FIELD

The present invention relates to a method, system and/or computer readable medium of instructions for delivery of electronic documents into postal networks. In a broad form of the invention, a graphic image file is created at a sender's computer terminal and transmitted to a server as part of an electronic document for onward delivery to a printing device, which produces a hardcopy document version of the graphic image file for delivery to a recipient via a standard postal or mail network.

### BACKGROUND OF THE INVENTION

A terminal can be a device in a networked data or information communications system which is capable of requesting and receiving information from local or remote information sources. The capability of the terminal to request and/or receive information can be provided by an application program, hardware or other such entity. A terminal may be provided with associated devices, for example an information storage device such as a hard disk drive and a display screen. A terminal may be a computer or computerized device, a personal computer (PC), a type of mobile or cellular phone, a mobile data terminal, a portable computer, a personal digital assistant (PDA), a pager, a thin client, or any other similar type of electronic device.

A computer network includes all forms of connected or communicating terminals having at least two terminals connected or communicating so as to be able to transfer information or data. A computer network includes any type of terminal or part thereof, which is capable of communicating with at least one other terminal. The communication of information or data can occur over any data communications network, computer network, wireless network, inter-network, intra-network, local area network (LAN), wide area network (WAN), the Internet and developments thereof, transient or temporary network, combinations of the above or any other type of network providing for computerized, electronic or digital devices.

A postal network can be any form of network or system for distribution of physical mail, such as hardcopy documents or letters, and includes government or private postal services, a firm of couriers, or any other network or system whereby a hardcopy document can be delivered to a recipient's physical address.

An application document can be a document produced by a user on a terminal using any application program, or received by a user on a terminal. Examples of application documents include word-processing documents produced by, e.g. Microsoft® Word®, a spreadsheet, an invoice produced from an accounting package, or a document produced by a desktop publishing package.

A graphic image file can be an electronic file with graphical information that can be used to reproduce an original application document in a form whereby what the user sees on the terminal screen is the same as when the graphic image file is printed. An example of a graphic image file would be a file in Microsoft Enhanced Metafile Format (EMF).

An electronic document can be an electronic file that can be stored on a terminal or transmitted over a computer network.

A hardcopy document can be a document printed on paper or a similar medium.

Currently, there are four known processes which result in physical delivery of a computer generated hardcopy document to an end recipient via a postal network.

Regardless by which process the hardcopy document is produced, the hardcopy document is typically placed in an envelope and delivered to a mail box, post office, or other postal collection point, for subsequent delivery of the letter (envelope and hardcopy document) by the postal network.

Manual Process

A manual process involves manual printing of a hardcopy document at a local printer connected to a computer, and physical delivery of the printed hardcopy document to a postal collection point (i.e. local post office collection box).

Currently the vast majority of hardcopy documents are submitted to the postal network via a process of printing an application document at the point of creation of the application document, placing the printed hardcopy document in an envelope to form a letter, addressing the letter, and manually delivering this to a postal collection point. A postal organization then collects the letter from the postal collection point, sorts the letter into an area for delivery using a post code or other location indicator technique, aggregates letters for each postal centre, and then physically delivers the letter to the postal center nearest to the recipient's address. This postal center nearest the recipient's address then sorts the letter and delivers the letter, with the hardcopy document, to the actual recipient's address.

Significant problems are associated with the described manual process for delivery of hardcopy documents. These include:
a) It is a labor intensive process for the sender of the hardcopy document. The sender must first print the application document to create the hardcopy document, often fold the hardcopy document, insert the hardcopy document into an envelope, and physically deliver the envelope with the hardcopy document to a postal collection point.
b) The letter enters the postal network at a point close to or closest to the sender, and not the recipient.
c) The hardcopy document is unable to be tracked from creation to delivery. Currently the letter can only be tracked after lodgment at the postal collection point, i.e. there is no tracking from the point of creation to the postal collection point.
d) The sender can insert other materials, like harmful biological or chemical agents, or other hazardous material, into the letter at the source prior to physically posting.
   Outsourced Printing

Outsourced printing involves using pre-defined fields in a template to generate a data file to be processed by a printer. Software at a printing house uses the data file and pre-defined template to produce the final hardcopy document. Once the hardcopy document is prepared for mailing it is delivered to a postal collection point from which stage the usual postal delivery process takes place.

Outsourced printing uses a process of rendering the application document for local printing, i.e. outsourced printing relies on the process of using a template and either manually, or via a data merge process, populating the fields on a template with data. This necessitates that the printing house offering the outsourced printing facilities must manipulate the data at their premises, either by merging data, or having the sender manually complete a template with details such as the address of the recipient.

Significant problems are associated with the described outsourced printing process for delivery of hardcopy documents. These include:
a) The remote host computer at the printing house offering the outsourced printing facilities is required to have prior knowledge of the type of application document it is to be receiving. This works by having a template setup on the printing house's remote host computer, and data is input to the remote host computer for merging with the template. This process is not efficient for single application document printing, or ad hoc changes to the appearance of the application document, as the software needs to be informed about any changes so that the templates can be changed.
b) The printing house's remote host computer cannot accept application documents from a variety of different originating application programs, without having some prior knowledge of how these application documents should be formatted.
c) Outsourced printing systems work on batch processes, in that these systems need to process all the printing for one client as a batch, before printing another client's job. For example, this means that these systems cannot accept one hundred different application documents originating from unrelated clients, and process them in one batch.
d) A letter enters the postal network at a point convenient for the printing house, which is not close to or closest the recipient's address.
e) An integrated tracking and identification system from the time of creation of the application document to delivery to the recipient's address is not provided.
f) Necessarily requires filling in of templates or predefined fields.
   Use of a Printer Driver

The Adobe printer driver and PDF Transit product use client-side PDF file creation, web browser job submission, pre-configured print provider's specifications, encryption, and server-side web acceptance of files.

This process involves using a printer driver to create a type of graphic image file locally, and then send the graphic image file, via the Internet or e-mail, for remote printing. An example of this would be where a sender creates an application document in Microsoft® Word®, and then uses a printer driver to create an Adobe® PDF format representation. The PDF could then be transmitted to a remote server which can print a hardcopy document version of the PDF. The hardcopy document can then be placed in the postal network. The sender may use email to forward the PDF, or may upload the PDF to a remote web server using a web browser or file transfer software. The process of transferring the PDF is a separate process that is initiated by the sender.

Significant problems are associated with the printer driver process for delivery of hardcopy documents. These include:
a) The printer driver process does not track the graphic image file or hardcopy document from creation at the sender's computer until delivery. No client terminal document manager is provided to view status updates or previously sent documents.
b) The sender is not provided with a check on the position and presence of the recipient's address in the hardcopy document to be generated. Without this feature, the address may not be in the correct position for a window envelope when received by a remote printer, which would render the hardcopy document unable to be delivered as the recipient's address would not show correctly through the window of the envelope.
c) There is no extraction of address data to look-up and produce, for example, a Delivery Point Identification (DPID).
d) There is no guarantee that the application documents intended to be sent by the sender correspond to the PDF documents received by a remote computer. Because this process involves manual steps, it is possible that the sender creates an application document for sending, but inadvertently selects a different graphic image file to send or upload for remote printing.
e) The hardcopy document enters the postal network at a postal collection point which may not be close or the closest collection point to the recipient's address. There is no intelligence in this process to automatically route the PDF document based on post code or other location indicator to a printing or postal location that is closer or closest to the recipient's address.
f) The printer driver process does not handle the billing of the transaction, that is the printer driver process does not make a record of the sender and create a record to bill the sender in an automated fashion. Also there is no ability to link each electronic document with any intermediary salespeople.
g) The printer driver process does not confirm or provide an update of delivery status to the sender when printing or delivery of the hardcopy document is completed.
h) There are no server rules or document quarantine processes.
   International Publication No. WO 99/21330

A system and method for transmission of a document from a sending location to a receiving location is disclosed in International Publication No. WO99/21330. This prior art specification discloses a system and method which has several disadvantages, including, inter alia: no verification on the sender computer that the recipient's address is in a correct position for a window envelope; no extraction of recipient address data for validity checks or to look up and merge with a DPID; no ability to reposition elements of the document; no server computer forwarding rules or document quarantine processes; no client computer software for managing documents, viewing a previously sent graphic image file or status updates; and no ability to link each document with a reseller or salesperson.

This identifies a need for a method, system, and/or computer readable medium of instructions to facilitate the delivery of a hardcopy document, obtained from an application document, into a postal network which overcomes or at least ameliorates at least some of the aforementioned or other problems in the prior art.

### SUMMARY OF THE INVENTION

The present invention provides a method, system, and/or computer readable medium of instructions to facilitate delivery of an application document to a recipient as a hardcopy document, the application document being used to produce a graphic image file, an electronic document being produced which includes at least the graphic image file and a unique identification number, and the electronic document being transmitted to a server for subsequent printing of the graphic image file on a selected printing device, the printing device being selected based on the printing device's location relative to the recipient's address, the printing device producing a hardcopy document which is then placed in the postal network. The hardcopy document is capable of being placed in the postal network at a location nearer, or nearest, or otherwise conveniently located, to the recipients address than would otherwise be the case if the sender printed and placed the hardcopy document in the postal network.

According to a further embodiment of the present invention, there is provided a method of delivering a hardcopy document, obtained from an application document, into a postal network. The method includes: an application document being created on, or sent to, a client terminal; client-side software resident on the client terminal can generate a graphic image file from the application document, the graphic image file can include a recipient's address; the graphic image file can be allocated a unique identification number; an electronic document can be generated which includes at least the graphic image file and the unique identification number; the electronic document can be transmitted over a computer network to a server; and server-side software can be resident on the server and can receive the electronic document and forward the graphic image file to be printed on a printer for subsequent entry of the printed hardcopy document into the postal network for physical delivery to the recipient's address.

In an embodiment, the graphic image file is routed to a particular printer based on the recipient's address. The printer is close or closest to, or most conveniently located to, the indicated recipient's address for printing of the hardcopy document for subsequent delivery into the postal network. In a further embodiment of the invention, the electronic document includes an instruction file. In another embodiment of the invention, the instruction file includes information from the set of: the unique identification number; a sender's account number or details; a unique identifier for the client terminal; a return email address; an identification number for an intermediate reseller; and/or printing instructions. In a further embodiment of the invention, a representation of the unique identification number is added to the hardcopy document.

According to embodiment of the present invention, there is provided a system for the delivery of a hardcopy document, obtained from an application document, into a postal network. The system can include a printer driver resident on a client terminal for generating a graphic image file from an application document, where the graphic image file includes a recipient's address. The system can also include client-side software resident on the client terminal for generating an electronic document that includes at least the graphic image file and a unique identification number. Additionally, the system can include server-side software resident on a server for receiving the electronic document transmitted over a computer network from the client terminal, and for forwarding the graphic image file for subsequent printing of the graphic image file on a printer and entry of the printed hardcopy document into the postal network for physical delivery to the recipient's address indicated in the graphic image file.

According to still another embodiment of the present invention, there is provided a computer readable medium of instructions for effecting delivery of a hardcopy document, obtained from an application document, into a postal network, the computer readable medium of instructions can reside on a client terminal and be adapted to: receive a graphic image file, where the graphic image file can be generated from an application document; check or facilitate the checking of the position of a recipient's address in the graphic image file to verify that the recipient's address is located in a correct position; associate a unique identification number with the graphic image file; produce an electronic document which includes the graphic image file and the unique identification number; and initiate transmission of the electronic document over a computer network to a server; whereby, server-side software resident on the server receives the electronic document and forwards the graphic image file for printing on a printer for subsequent entry of the printed hardcopy document into the postal network for physical delivery to the recipient's address.

If the recipient's address location is not in a correct position the sender is prompted and given the opportunity to correct the position of the recipient's address prior to sending the electronic document. A copy of the graphic image file can be saved on the client terminal for later viewing.

According to still another embodiment of the present invention, there is provided an article, for use in the delivery of a hardcopy document obtained from an application document created on, or sent to, a client terminal, the client terminal provided with client-side software for generating a graphic image file from the application document, the graphic image file including a recipient's address and allocated a unique identification number, an electronic document generated by the client-side software which includes at least the graphic image file and the unique identification number. The article can include a computer readable modulated carrier signal and the electronic document embedded in the signal. A. server receives the signal and server-side software resident on the server is adapted to forward the received graphic image file for printing on a printer for subsequent entry of the printed hardcopy document into the postal network for physical delivery to the recipient's address.

It should be noted that the application document itself need not necessarily actually be produced on the client terminal, the application document could be produced elsewhere and sent to the client terminal. Also, the sender need not necessarily be the creator of the-application document.

In another embodiment of the invention, a representation of the unique identification number is added to the hardcopy document, for example as a bar code or magnetic code, and this representation of the unique identification number can be used to track the hardcopy document within the postal network until the hardcopy document reaches the recipient or recipient's address. If an optical code, such as a bar code, is used the code can be readable through the window of an envelope. This allows the document to be tracked from creation to delivery in both electronic and physical form.

In a further embodiment of the invention, the server (or network of servers) receives notification of printing and onward delivery of the hardcopy document and updates records in a database, and/or notifies the sender of this action by electronic mail. Details of the transaction can also be recorded in the database for billing purposes.

In another embodiment of the present invention, an electronic document received by the server can be quarantined on the server if a sender's account is not active, for example if the sender has not made previous payments, has no account or has no credit. An electronic notification can be sent to the client terminal alerting the sender to the electronic document having been quarantined.

The graphic image file is routed to a printer close or closest to, or most conveniently located to, the indicated recipient's address. Also, the sender is only required to instruct the client-side software to transmit the electronic document to the server, with the client-side software and/or server-side software handling further aspects of delivery into the postal network.

In various alternative embodiments of the present invention, the position of the recipient's address in the graphic image file can be checked by the client-side software, the sender, by way of the graphic image file being presented in a preview screen with a recipient address boundary mask overlaid, and/or the server-side software rechecking the position.

In another embodiment of the invention, the client-side software resident on the client terminal, or the server-side software, extracts the text positioned at the location of the recipient's address area from the graphic image file and attempts to verify that the text constitutes a valid address. For example, by checking that a valid postcode or suburb name has been included. In another embodiment of the invention, optical scanning recognition software is used to convert the recipient address component of the graphic image file to text form, which is then checked to seek to verify that the text constitutes a valid address.

According to still further embodiments of the invention, the graphic image file can be checked to verify the graphic image file can be processed by a mailhouse. The checks can include: that the fonts in the graphic image file are supported by the mailhouse; an address is provided; and/or a valid address is provided according to parameters for correct addressing in the destination country. Also, the graphic image file could be moved or re-sized to allow for page barcodes, or other indicia inserted by the mailhouse.

In another embodiment of the invention, the client-side software, or the server-side software, reads and looks up the recipient's address in a postal address file and generates an address representation, for example a barcode representation of the recipient's address or a suitable Delivery. Point Identification (DPID) to facilitate transmission to an appropriate printer and/or the recipient.

In a further embodiment of the present invention, the client-side software allows the sender to preview the graphic image file and displays an overlay or mask showing the preferred location for the recipient's address. Moreover, the client-side software allows the sender to relocate or delete the graphical elements that form the graphic image file whilst in this preview mode. For example, the position of the recipient's address could be relocated if not within the preferred location. The software may also provide the sender with the option to delete components in the address area and to manually type in text indicating a correct address, which is then incorporated into the graphic image file before transmission of the electronic document to the server.

The client-side software can compress and/or encode the graphic image file into a format suitable for electronic transmission. Furthermore, according to an embodiment, the client-side software encrypts the electronic document using public key encryption before electronically transmitting the electronic document to the server. The electronic document can also be digitally signed.

The server is programmed with rules that enable the server to forward the graphic image file from the received electronic document to a printer close or closest to, or most conveniently located to, the recipient's address.

According to a further embodiment of the invention, in the case where the application document consists of a set of separate documents to be delivered to separate recipients—for example, the results of a mail merge job in a word-processing application—special codes are incorporated at the end and/or beginning of the mail merge template to establish the start and the end of individual application documents. This allows a large mail merge job to be separated into the individual component documents at the client terminal, which further allows the documents to be processed on the server without human intervention. Also, an analysis of the structure of each application document can be performed to determine start and end points of each of the documents or collection of documents.

In another embodiment of the invention, each printer may be managed by a printer server which receives the graphic image file and sends an electronic notification message back to the originating server.

In a further embodiment, the printers are integrated into the postal network and all necessary facilities for printing, folding, inserting and lodgment of hardcopy documents into the postal network is provided.

In yet another embodiment, each printer can be managed by a server computer (or network of servers) which manages the process of receiving the graphic image files, decoding the graphic image files, and printing the hardcopy document. In another embodiment, these printer servers can be programmed with rules to forward graphic image files to other printers in the event of printer breakdown or overloading.

According to another embodiment, the system/method can be designed to operate as a multi-level distribution system/method where intermediate resellers and individual salespersons can be cross-linked to the final mailed hardcopy document and be provided with a commission based on transaction value.

### BRIEF DESCRIPTION OF THE DRAWINGS

The present invention should become better understood from the following detailed description of a preferred but non-limiting embodiment thereof, described in connection with the accompanying figures, wherein:

FIG. 1 illustrates a general system providing an embodiment of the invention;

FIG. 2 illustrates how the client terminal can query the delivery status of an electronic document; and

FIG. 3 illustrates a possible billing system structure.

### DETAILED DESCRIPTION OF THE INVENTION

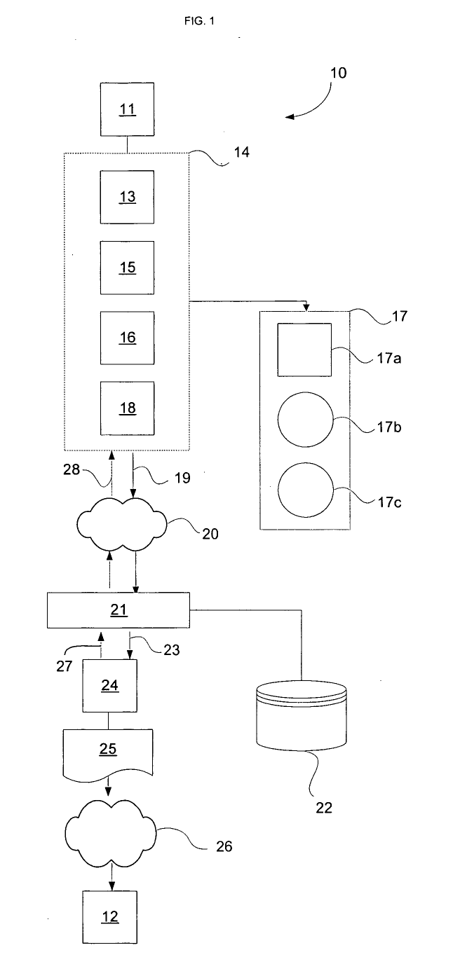

In an embodiment of the present invention, there is provided a method, system, and/or computer readable medium of instructions to facilitate delivery of a hardcopy of an application document via a postal network. Embodiments of the present invention are described with reference to FIGS. 1 to 3.

Referring to FIG. 1, there is illustrated a system 10 for facilitating a sender 11 to post a hardcopy document of an application document to a recipient 12. The application document 13 is created on the client terminal 14 by the sender 11 using a software application. Alternatively, the application document 13 may simply be received on the client terminal 14, being created on a different terminal.

The sender 11 uses software resident on the client terminal 14 to convert the application document 13 into a graphic image file by using an image capture tool 15. This image capture tool can exist as a printer driver which can be selected from within a standard software program provided with a print function. This produces a graphic image file from the application document, or multiple graphic image files of a multiple page application document.

The automated address checking procedure 16 checks the location of the recipient's address in the graphic image file. The automated address checking procedure 16 can also check that the postal address is valid. The automated address checking procedure 16 determines if there is text in the correct location or uses a preview screen with a mask overlay to determine address field boundaries, or allow the sender to manually inspect the address position. If there is text and the text appears to be a valid address, for example there is a recognizable postcode or suburb name, then the automated address checking procedure 16 can generate a barcode representation of the address and/or look up the address in a postal address file and generate a suitable address representation (e.g. barcode) or Delivery Point Identification (DPID) to assist in forwarding the graphic image file to an appropriate printer. If the address is not satisfactory or not valid, the software can prompt the sender 11 to correct the address. In an alternative particular embodiment, the user checks the address location visually using a preview screen with a boundary mask showing the correct location of the address. In a further alternative embodiment, the sender can type in the recipient's address manually or retrieve the recipient's address from an electronic address book database on the terminal.

According to various embodiments of the present invention, the following general steps can be provided:
1. Letters and attachments, as application documents, are captured or generated using a printer driver.
2. The graphic image file produced by the printer driver has a default standard address area, that may or may not correspond to a standard location for the address to be visible through the window of a window envelope. The default standard address area occurs if no previous manual selection has been made.
3. The address location that was last manually selected by the user/sender can be remembered, for example if the application document has the same name or other indicator.
4. The user can overwrite any automatic or previous manual address location selection by manually selecting an address area. This manual selection can occur by the user making a single mouse click, multiple mouse clicks, or drawing or dragging a rectangle around or over all or part of the address.
5. Application documents or graphic image files can be automatically identified and an associated target address can be extracted, even if parts of the address stray outside of a selected address area.
6. Margins in an application document or corresponding graphic image file can be checked to ensure that room is provided for page barcodes, optical mark recognition codes, or other suitable identifiers/codes. If the margins are too small the page image can be automatically, or manually, shifted or reduced to clear the required margin space.
7. The address location/window can be checked to see that it only includes the target or intended address. If the address window is not clear, i.e. it may contain unwanted text or images, a cover page can be added to the graphic image file (i.e. letter to be mailed) with the address located in a correct position on the cover page, for example for correct display of the address through the window of a window envelope. The address location in the cover sheet could be inserted or manipulated as per preceding steps 2, 3 or 4.
8. Optionally, the target address can be analyzed to check that it appears to be a correct or valid address. This process may occur on the client terminal, it could occur on the server. The address may be corrected according to local postal standards, for example for format, barcode or DPID. If the address is amended, the new address is then placed in the address window, whether it be a first page of a letter or a cover page as previously discussed. Alternatively, the address can be checked against a database of correct or valid addresses. If the address does not match, an address from the database can be used. The database could reside local or remote to the client terminal.
9. Page barcodes, optical mark recognition codes, or other suitable identifiers/codes, can be added to any or all of the pages of the graphic image file (letter), including any cover sheet.
10.A graphic image file, i.e. letter, once transmitted, can then be sorted according to local postal standards, for example by postcode or suburb, and then printed, folded, inserted into an envelope for entry into the standard physical postal network.

When the recipient's address is satisfactory, the graphic image file could be compressed and encoded, the client-side software then creates an electronic document 17 which includes the graphic image file 17a, a unique identification number 17b (for tracking the graphic image file or electronic document) and an instruction file 17c. The electronic document 17 can also be encrypted and can include a digital signature. Also, the unique identification number 17b may form part of the instruction file 17c. The instruction file 17c can be an XML file containing instructions for the handling of the electronic document 17, for example the instruction file 17c may contain, inter alia the unique identification number 17b, used to track the electronic document and for billing purposes, the sender's account number or details, used for billing and verification purposes, and for the prevention of fraudulent use, and a unique identifier for the client terminal 14, used for tracking and verification of authenticity. It may also contain the number of pages or a return email address, identification numbers for any intermediate resellers, and any individual salespersons, who are involved in a multi-level distribution of the present system, the identification numbers could be used to calculate commissions due to salespersons or sales-teams, for example the intermediate reseller identification numbers can be stored in the database 22 indexed against the sender's account number; and additionally may contain printing instructions, for example color or black and white, post via express mail.

The electronic document 17 is passed to a queue manager 18 and then electronically transmitted 19 from the client terminal 14 over the computer network 20 to the server computer 21 (which may be a network of computers). The queue manager 18 can send the electronic document 17 immediately or send several electronic documents in a batch. A server computer message handler receives the electronic document 17, and if required performs decoding/decrypting, verifies the digital signature, and extracts the recipient's address, postcode and/or DPID from the instruction file 17c. Optionally, the server-side software resident on the server 21 can perform further address checking, similar to the automated address checking procedure 16 on the client terminal 14, as an additional checking procedure.

The server-side software can handle incoming electronic documents, check the sender's account status, parse the instruction file associated with an electronic document, decode any encoded format files, decrypt and verify data, extract a recipient's address, track the incoming electronic document, record billing data, handle errors, manage the printing of the hardcopy document, re-encrypt and forward an electronic document to another remote server, or transmit the electronic document using another form of communication.

An electronic document 17 received by the server 21 can be quarantined on the server 21 if a sender's account is not active, for example if the sender has not made previous payments, has no account or has no credit. An electronic notification 28 can be sent to the client terminal 14 alerting the sender 11 to the electronic document 17 having been quarantined.

After verifying the sender's account details, this information is passed to a message forwarder in the server computer 21 which follows a set of rules to decide which is a suitable mail distribution center printer to receive the graphic image file 17a, for example which is the closest mail distribution center printer to the recipient's address. Information concerning the receipt or transmittal of electronic documents, graphic image files or any other information relating to the transaction, for example data from the instruction file 17c, can be recorded in the database 22.

The graphic image file 17a is electronically transmitted 23 to the selected printer/printer server 24, and the server 21 records the transaction in the database 22, which can be indexed by the unique identification number 17b.

The printer/printer server 24 sends an electronic notification message 27 back to the server computer 21 detailing the results of the printing operation. On receipt of the electronic notification message 27, the server-side software updates the database 22 and, either automatically or if requested (i.e. optionally), forwards a further electronic notification message 28 to the client terminal 14 so as to inform the sender 11 of the success, or otherwise, of the delivery of the hardcopy document 25 into the postal network 26. The electronic notification message 28 could also be initially either automatically or if requested (i.e. optionally), transmitted to the client terminal 14 to confirm receipt of the electronic document 17 by the server 21.

In an alternate embodiment of the invention, the complete electronic document 17 could be sent to the printer server. If the complete electronic document 17 is transmitted, the electronic document 17 is received by the printer server's message handler, which, if required, decodes the electronic document 17 and sends the graphic image file 17a to it's local printer.

The resulting hardcopy document 25 is inserted into an envelope to form a letter which is then submitted into the postal network 26 for distribution to the recipient's address, and thus the recipient 12, via the postal network 26. The formation of the letter could be an automated process performed at the mail distribution center.

In a further embodiment, server-side software resident on the server 21 reads the recipient's address and generates a suitable barcode or DPID, or uses a barcode or DPID generated at the client terminal 14, so as to add the barcode or DPID to the hardcopy document 25 or the envelope for faster, cheaper or more efficient delivery via the postal network 26.

In a further embodiment of the present invention, the splitting of mail merges into individual letters is provided. A mail merge is a set of similar documents generated on a computer and intended for multiple recipients. It is normally sent to a printer as a single document print job and the user then is required to manually sort the printed hardcopy pages for each recipient. Therefore, if the mail merge is a two-page document to one hundred recipients, it is sent to the printer as a single two hundred page document. The system of the present invention uses special codes at the end and/or beginning of a mail merge template to establish the start and the end of each individual document and can therefore break-up a two hundred page single document into the one hundred separate two-page documents. This therefore allows the system to automatically process the documents on the server without human intervention. If this was not the case, it would be required to manually process/sort the documents before posting, or the first recipient would receive all the merged documents in the post. This allows the mail merge to be performed on the client terminal 14 rather than the server 21. This same principle applies to any job where multiple letters are sent to the printer as one job, i.e. end of month statement runs, etc. Alternatively, the entire mail merge job can be sent as a whole and the processing into separate documents is carried out by software on the server.

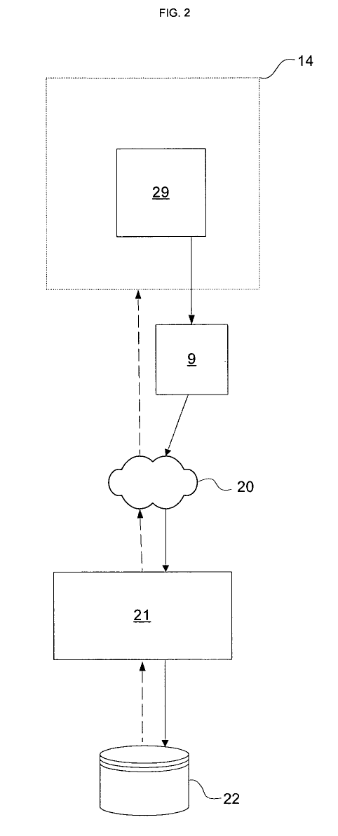

Referring to FIG. 2, the sender 11 can use a document manager 29 on the client terminal 14 to view a summary of all electronic documents sent and their status. The document manager 29 can also be used to preview any electronic documents or graphic image files sent to the server 21. The document manager 29 transmits a query 9 to the server 21 via computer network 20. This results in a query of the database 22 for the most recent status, for example a status could relate to an electronic document or graphic image file being queued, sent, received, printed, posted, failed. Also, there is provided a local client-side database or file record which is regularly updated whenever the database 22 is queried.

In another embodiment, access to the status of delivery of documents can be provided by allowing a sender 11 to log into the server 21 via a web browser and query the status of electronic or hardcopy documents by using the unique identification number and an account number and password.

In a further embodiment, a mail distribution center, for example a local post office, prints the graphic image file 17a. This ensures that the first time the hardcopy document 25 enters the postal network the hardcopy document 25 is free from dangerous biological or chemical agents, or other hazardous material. This procedure also ensures that the hardcopy document 25 is “least cost” routed by electronic means to a physical printing point closest or close to the recipient's address, and not the sender. That is, physical transportation costs associated with hardcopy documents are reduced.

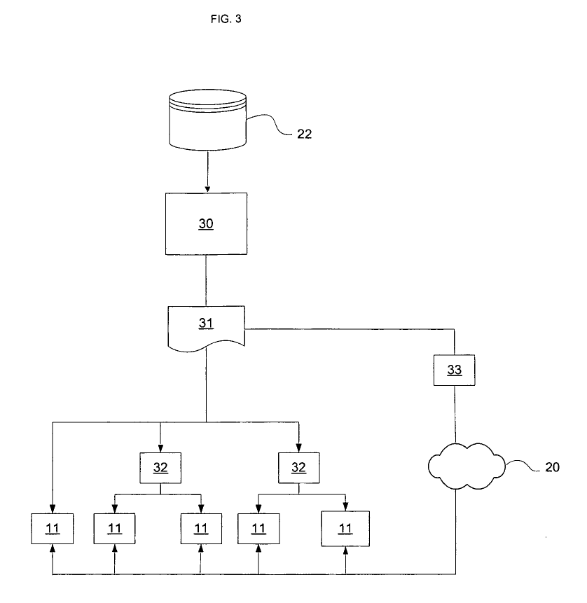

According to a further embodiment of the present invention, and referring to FIG. 3, a billing system 30 is shown that can periodically, for example monthly, retrieve information from the database 22 to produce an invoice 31 of charges accrued for each sender 11, or for any intermediate resellers 32 offering the system or method of the present invention. The billing system 30 can also produce a periodic, for example daily, journal 33 of transactions for each sender 11. If requested, the journal 33 may be transmitted to each sender 11 via the computer network 20. This allows an intermediary payment structure to be set-up for allocating commission payments to various parties.

A further embodiment of the present invention uses a computer program that runs on the sender's computer. The computer program can consist of software that can be written in the C programming language that can run on the Microsoft® Windows® 32-bit operating system (WIN32) together with a custom printer driver, which can be developed using the Microsoft® Windows® Driver Development Kit (DDK).

After the sender has created or received an application document on their WIN32 computer terminal, the sender can select a custom printer driver which “prints” the application document by saving the application document as a series of Enhanced Metafile Format (EMF) files on the terminal's storage medium. The printer driver then, in turn, initiates the client-side software. The software displays the EMF files in WYSIWYG format on the sender's (i.e. user's) computer screen with the relevant area for the correct location of the postal address highlighted. Thus the sender can tell by inspection that the recipient's address is in the correct location and can instruct the software to send an electronic document or cancel the operation. In an alternative embodiment, the software automatically examines the EMF file for graphical text elements in the relevant area of the page and then analyzes this text according to pre-programmed rules to ascertain whether the document contains a valid postal address.

The EMF files can then be digitally compressed using the ZLIB compression algorithm as specified in RFC1950 “ZLIB Compressed Data Format Specification version 3.3” (P. Deutsch and J -L Gailly, May 1996) and can then be encoded using Basic Encoding Rules (BER) in accordance with ITU-T Recommendations X.690-X.691 (2002) and CCITT Recommendation X.209.

The software can generate a unique identification number by using Windows internal software that creates a global unique identifier (GUID), a bit string guaranteed to be unique to a very high degree of certainty. This number can be encoded in base 24 format and may be used as a reference to the message in all subsequent stages, and also as key in a local database of messages maintained by the software on the sender's local terminal.

The software can then generate an instruction file in Extensible Markup Language (XML) containing instructions for this particular message including the unique identification number, sender's account details, number of pages, return email address, and so forth. This XML instruction file can be combined with the BER-encoded EMF files and converted into a Secure Multipurpose Internet Mail Extensions (S/MIME) message using public key encryption in accordance with RFC2633 “S/MIME Version 3 Message Specification” (B. Ramsdell, June 1999) and RFC2630 “Cryptographic Message Syntax” (R. Housley, June 1999).

The software can then open a Transmission Control Protocol/Internet Protocol (TCP/IP) connection with the server computer over the Internet and sends the S/MIME message to the server using the Simple Mail Transfer Protocol (SMTP) as per RFC821. This SMTP transmission is independent of any email client applications that may exist on the sender's terminal. Alternatively, the software stores the information in a queue so the message can be sent by SMTP transmission at a later time. After transmission, the software stores the result (success or failure) in the local database.

When the sender uses a Document Manager to query the status of documents, the software looks up the local database for the identifiers of any outstanding documents. It then sends a request on these outstanding documents to the server computer using Hypertext Transfer Protocol (HTTP) commands and receives back the latest status details (received, being printed, successfully posted, rejected, not found, etc). The software then updates the local database with this information and displays the results to the user in a Graphical User Interface (GUI).

Thus there has been provided a method, system, and/or computer readable medium of instructions to facilitate the delivery of a hardcopy document, attained from an application document, into a postal network, at a postal center close or closest to a recipient's address.

The invention may also consist in the parts, elements and features referred to or indicated in the specification of the application, individually or collectively, in any or all combinations of two or more of said parts, elements or features, and where specific integers are mentioned herein which have known equivalents in the art to which the invention relates, such known equivalents are deemed to be incorporated herein as if individually set forth.

Although the preferred embodiment has been described in detail, it should be understood that various changes, substitutions, and alterations can be made herein by one of ordinary skill in the art without departing from the spirit or scope of the present invention.

1. A method of delivering a hardcopy document, obtained from an application document, into a postal network, the method comprising the steps of:
one of creating on and sending an application document to a client terminal;
generating, by client-side software resident on the client terminal, a graphic image file from the application document, the graphic image file including a recipient's address;
allocating the graphic image file a unique identification number;
generating an electronic document which includes at least the graphic image file and the unique identification number;
transmitting the electronic document over a computer network to a server; and
receiving, on a server-side software resident on the server, the electronic document and forwarding the graphic image file to be printed on a printer for subsequent entry of the printed hardcopy document into the postal network for physical delivery to the recipient's address.

2. The method as claimed in claim 1, further comprising the step of routing the graphic image file to a particular printer based on the recipient's address.

3. The method as claimed in claim 1, further comprising the step of locating the printer to at least one of close, closest to, and most conveniently to the indicated recipient's address for printing of the hardcopy document for subsequent delivery into the postal network.

4. The method as claimed in claim 1, further comprising the step of including in the electronic document an information file instruction file.

5. The method as claimed in claim 4, further comprising the step of including the information file instruction file information selected from a group consisting of:
the unique identification number;
a sender's account number or details;
a unique identifier for the client terminal;
a return email address;
an identification number for an intermediate reseller; and
printing instructions.

6. The method as claimed in claim 1, further comprising the step of adding a representation of the unique identification number to the hardcopy document.

7. The method as claimed in claim 6, wherein the representation of the unique identification number is at least one of a bar code, optical code and magnetic code.

8. The method as claimed in claim 6, wherein the representation of the unique identification number is used to track the hardcopy document in the postal network.

9. The method as claimed in claim 6, wherein the representation of the unique identification number is readable through a window of an envelope containing the hardcopy document.

10. The method as claimed in claim 1, wherein the position of the recipient's address in the graphic image file is checked to verify that the recipient's address is located in a correct position.

11. The method as claimed in claim 10, wherein if the position of the recipient's address in the graphic image file is not correct the sender is notified.

12. The method as claimed in claim 1, further comprising the step of correcting the position of the recipient's address in the graphic image file by the sender.

13. The method as claimed in claim 1, further comprising the step of checking, by the client-side software, the position of the recipient's address in the graphic image file.

14. The method as claimed in claim 1, wherein the position of the recipient's address in the graphic image file is checked visually by the sender being presented with a preview screen.

15. The method as claimed in claim 1, wherein the graphic image file can be on of moved and re-sized to allow for at least page barcodes by a mailhouse.

16. The method as claimed in claim 15, further comprising the step of displaying, by the preview screen, an overlay mask showing a preferred location for the recipient's address.

17. The method as claimed in claim 1, further comprising the step of checking the position of the recipient's address in the graphic image file by the server-side software.

18. The method as claimed in claim 1, further comprising the step of deleting by the sender components in the address area of the graphic image file and manually type text changing the recipient's address.

19. The method as claimed in claim 1, further comprising the. step of inserting the recipient's address in the graphic image file from an electronic address book by the sender.

20. The method as claimed in claim 1, further comprising the step of generating multiple application documents at the client terminal from a mail merge process.

21. The method as claimed in claim 20, further comprising the step of performing an analysis of the structure of each application document to determine start and end points of each of the documents or collection of documents.

22. The method as claimed in claim 1, further comprising the step of quarantining an electronic document received by the server.

23. The method as claimed in claim 1, further comprising the step of integrating the printer into a postal network infrastructure.

24. The method as claimed in claim 23, wherein the postal network infrastructure includes at least one device for printing, folding, inserting into envelopes, and lodgment of hardcopy documents into the postal network for subsequent physical delivery.

25. The method as claimed in claim 1, further comprising the step of managing each printer by at least one printer server.

26. The method as claimed in claim 25, further comprising the steps of:
sending the electronic document to the printer server; and
extracting the graphic image file.

27. The method as claimed in claim 1, further comprising the step of sending electronic documents to the server one of immediately and a batch process.

28. The method as claimed in claim 1, further comprising the step of cross-linking at least one of an intermediate reseller and salesperson to the hardcopy document.

29. The method as claimed in claim 28, further comprising the step of receiving a commission, by at least one of the intermediate reseller and salesperson, as a result of the delivery process.

30. A system for the delivery of a hardcopy document, obtained from an application document, into a postal network, the system comprising of:
a printer driver resident on a client terminal for generating a graphic image file from an application document, the graphic image file including a recipient's address;
client-side software resident on the client terminal for generating an electronic document that includes at least the graphic image file and a unique identification number; and
server-side software resident on a server for receiving the electronic document transmitted over a computer network from the client terminal, and for forwarding the graphic image file for subsequent printing of the graphic image file on a printer and entry of the printed hardcopy document into the postal network for physical delivery to the recipient's address indicated in the graphic image file.

31. The system as claimed in claim 30, wherein the client-side software facilitates at least one of the automatic and manual checking of the position of the recipient's address in the graphic image file.

32. The system as claimed in claim 30, wherein the client-side software facilitates at least one of the automatic and manual checking of the content of the recipient's address in the graphic image file.

33. The system as claimed in claim 31, wherein the client-side software facilitates the sender to amend at least one of the recipient's address position and content directly in the graphic image file.

34. The system as claimed in claim 30, wherein a database is associated with the server.

35. The system as claimed in claim 34, wherein the database is in communication with at least the server and stores information pertaining to the delivery of electronic documents and hardcopy documents.

36. The system as claimed in claim 30, wherein the electronic document includes an information file instruction file.

37. The system as claimed in claim 36, wherein the information file instruction file includes information selected from a group consisting of:
the unique identification number;
a sender's account number or details;
a unique identifier for the client terminal;
a return email address;
an identification number for an intermediate reseller; and
printing instructions.

38. The system as claimed in claim 36, wherein the instruction file is an XML file.

39. The system as claimed in claim 35, wherein the server receives notification of printing of the hardcopy document and updates records in the database.

40. The system as claimed in claim 30, wherein a document manager is provided on the client terminal.

41. The system as claimed in claim 40, wherein the document manager displays a summary of the status of sent electronic documents.

42. The system as claimed in claim 40, wherein the document manager can submit a query to the server which queries the database for status information.

43. The system as claimed in claim 35, wherein there is additionally provided at least one of a further database and file record associated with the client terminal that is updated when information is received from the database associated with the server.

44. The system as claimed in claim 30, wherein the server automatically electronically notifies the client terminal of electronic and hardcopy delivery actions.

45. The system as claimed in claim 44, wherein the electronic notification is by email.

46. The system as claimed in claim 34, wherein an authorized sender is able to remotely connect to the server and query the database.

47. The system as claimed in claim 34, wherein delivery transactions are recorded in the database for billing purposes.

48. The system as claimed in claim 34, wherein an invoice for a sender is generated from database records.

49. The system as claimed in claim 30, wherein an electronic document received by the server can be quarantined and an electronic notification sent to the sender altering the sender of the quarantine action.

50. The system as claimed in claim 30, wherein the client-side software performs at least one of compression or encoding the graphic image file.

51. The system as claimed in claim 30, wherein the client-side software encrypts the electronic document.

52. The system as claimed in claim 30, wherein the electronic document is digitally signed.

53. The system as claimed in claim 30, wherein the server is programmed with forwarding rules.

54. The system as claimed in claim 53, wherein the forwarding rules nominate the printer that is at least one of close, closest to, and most conveniently located to the indicated recipient's address for printing of the hardcopy document for subsequent delivery into the postal network.

55. The system as claimed in claim 30, wherein each printer is managed by at least one printer server.

56. The system as claimed in claim 55, wherein the printer server that receives the graphic image file sends an electronic notification back to the originating server.

57. The system as claimed in claim 30, wherein the electronic document is sent to a printer server which extracts the graphic image file.

58. The system as claimed in claim 55, wherein a printer server is programmed with rules to forward graphic image files to another printer server in the event of a printer breakdown or overloading.

59. A method of facilitating delivery of an application document to a recipient as a hardcopy document comprising the steps of:
using the application document to produce a graphic image file including a recipient's address;
producing an electronic document which includes at least the graphic image file and a unique identification number for tracking the electronic document and the hardcopy document;
transmitting the electronic document to a server for forwarding and subsequent printing of the graphic image file on a selected printing device;
selecting the printing device based on the printing device's physical location relative to the recipient's address; and
using the printing device to produce the hardcopy document which is placed in the postal network for delivery to the recipient.

60. The method as claimed in claim 59, further comprising the step of generating the recipient's address automatically in a default address area.

61. The method as claimed in claim 59, further comprising the step of manually altering and storing the recipient's address area.

62. The method as claimed in claim 59, further comprising the step of checking margins in the graphic image file.

63. The method as claimed in claim 62, further comprising the step of at least one of shifting and reducing the image to clear the required margin space if the margins are too small.

64. The method as claimed in claim 59, further comprising the step of adding a cover page to the graphic image file if the recipient's address window is not clear.

65. The method as claimed in claim 59, further comprising the step of analyzing the recipient's address to check that it appears to be at least one of a correct and valid address.

66. The method as claimed in claim 65, further comprising the step of correcting the recipient's address to accord with a postal standard.

67. The method as claimed in claim 65, further comprising the step of checking the address against a database of correct or valid addresses.

68. The method as claimed in claim 59, further comprising the step of adding at least one of page barcodes, optical mark recognition codes, and other suitable identifiers/codes to at least one of any and all of the pages of the graphic image file.

69. The method as claimed in claim 59, further comprising the step of checking the graphic image file to verify the graphic image file can be processed by a mailhouse.

70. The method as claimed in claim 69, wherein the checks include at least one of:
that the fonts in the graphic image file are supported by the mailhouse;
an address is provided; and
a valid address is provided according to parameters for correct addressing in the destination country.
